(19) United States
(12) Patent Application Publication
(10) Pub. No.: US 2010/0268977 A1
(43) Pub. Date: Oct. 21, 2010

(54) METHOD AND APPARATUS FOR ACCESSING MEMORY UNITS

(75) Inventor: Chih-Ming Chang, Tainan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HIMAX MEDIA SOLUTIONS, INC., Tainan County (TW)

(21) Appl. No.: 12/425,420

(22) Filed: Apr. 17, 2009

(51) Int. Cl. G06F 1/06; G06F 12/06

(52) U.S. Cl. 713/500; 711/105; 711/E12.083

(57) ABSTRACT

An apparatus for accessing a memory is provided, and comprises a first device, a second device, an adjusting unit, a buffer and a memory. The first device operates at a first clock. The second device operates at a second clock. The buffer reads data from the second device to be written to the memory unit and reads from the memory unit to be read by the first device. The adjusting unit masks a portion of pulses of the first clock to generate an adjusted clock, wherein the first device reads the buffer according to the adjusted clock. The apparatus for accessing a memory is a video processor, and the first device and the second device are an input unit and an output unit of the video processor.

### BACKGROUND OF THE INVENTION

1. Field of the Invention

The invention relates to a method and apparatus for accessing a memory and in particular to a method and apparatus for accessing video data from a dynamic random access memory.

2. Description of the Related Art

Dynamic Random Access Memory (DRAM) is important for electronic devices because of its low cost and storage ability. However, when different devices with different access speeds want to access memory simultaneously, a DRAM is not capable of immediately and simultaneously responding to all of the requests. In extreme cases, bus jam will occur. In other cases, lower cued requests may be rejected. Thus, the system efficiency of electronic devices is lowered.

FIG. 1 is a schematic diagram of conventional access of a memory 100. The apparatus for accessing a memory unit is a video processor, and a first device and a second device are an input unit and an output unit of the video processor. A buffer 106 is set among a first device 102, a second device 104 and a memory unit 108. The first device 102 and the second device 104 access data in the buffer 106 by a first clock rate CLK_1 and a second clock rate CLK_2 respectively. The buffer 106 accesses data in the memory unit 108 by a memory clock rate CLK_M according to the memory unit 108. Moreover, the buffer 106 further comprises a first FIFO (First in First out buffer) 105, a second FIFO 107 and an arbiter 109. The arbiter 109 is set among the memory unit 108, the first and second FIFO 105, 107, and the arbiter 109 selects the first FIFO 105 or the second FIFO 107 to access data in the memory unit 108 by the memory clock rate CLK_M. In the FIG. 1, the first device 102 writes data to the memory unit 108 through the first FIFO 105 and the arbiter 109, and the second device 104 reads data from the memory unit 108 through the second FIFO 107 and the arbiter 109.

When the difference between the second clock rate CLK_2 and the third clock rate CLK_M is quite large and the second clock rate CLK_2 is faster than the third clock rate CLK_M, the memory unit 108 services the second device 104 all the time. That is, the second device 104 occupied the bus all the time, and the data from the first device 102 can not be written into the memory unit 108.

Embodiments of the invention provides a method and apparatus for accessing memory (DRAM) to solve the problems of the prior art.

### BRIEF SUMMARY OF THE INVENTION

An embodiment of the invention provides an apparatus for accessing a memory unit. The apparatus for accessing a memory unit comprises an adjusting unit, a first device, a second device, a buffer and a memory unit. The first device first device operates at a first clock. The second device operates at a second clock. The buffer coupled to the first device and the second device and reads data from the second device to be written to the memory unit and from the memory unit to be read by the first device. The adjusting unit masks a portion of pulses of the first clock to generate an adjusted clock, wherein the first device reads the buffer according to the adjusted clock.

An embodiment of the invention provides a method for accessing a memory unit through a buffer, and the buffer reads data from a second device to be written to the memory unit and from the memory unit to be read by a first device, wherein the first device is operated at a first clock and the second device is operated at a second clock. The method for accessing a memory unit comprises: generating an adjusted clock by masking a portion of pulses of the first clock; and reading the buffer according to the adjusted clock by the first device.

### BRIEF DESCRIPTION OF THE DRAWINGS

The invention can be more fully understood by reading the subsequent detailed description and examples with references made to the accompanying drawings, wherein:

FIG. 1 is a schematic diagram of conventional access of a memory 100.

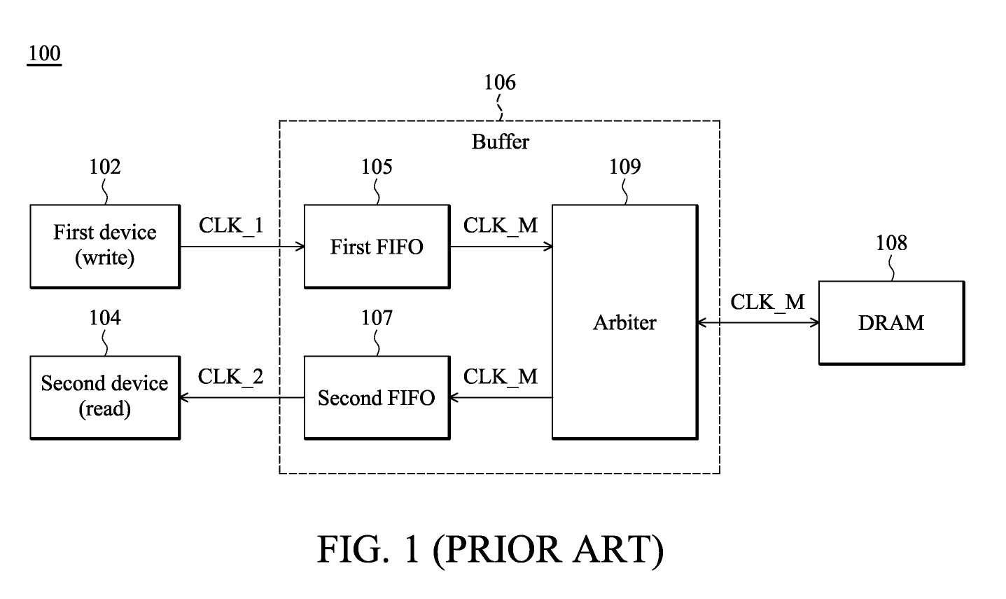

FIG. 2 is a schematic diagram of access of a memory 200 according to an embodiment of the invention.

FIG. 3 is a timing chart of the first clock CLK_1 and the adjusted clock CLK_GATE in FIG. 2.

FIG. 4 is a flow chart for accessing a memory according to one embodiment of the invention.

### DETAILED DESCRIPTION OF THE INVENTION

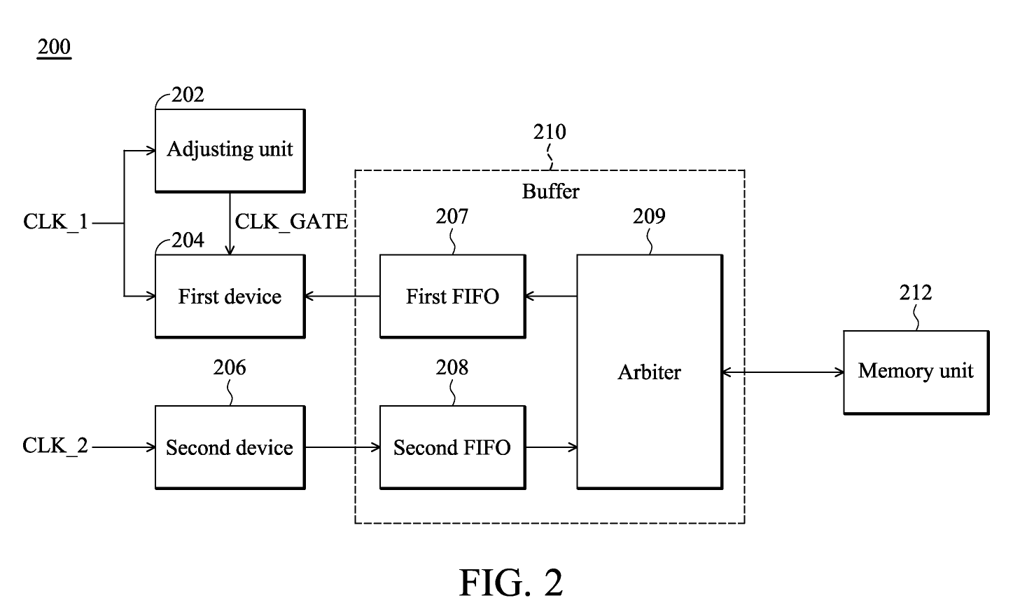

FIG. 2 is a schematic diagram of access of a memory 200 according to an embodiment of the invention. To access the memory 200, the memory 200 comprises an adjusting unit 202, a first device 204, a second device 206, a buffer 210 and a memory unit 212. The apparatus for accessing a memory unit is a video processor, and the first device and the second device are an input unit and an output unit of the video processor. In this specification, the term “unit” is used to denote a circuit, a piece of program, or their combination. The adjusting unit 202 receives a first clock CLK_1 and masks a portion of pulses of the first clock CLK_1 to generate an adjusted clock CLK_GATE. The first device 204 receives the first clock CLK_1, and operates according to the first clock CLK_1. The first device 204 reads data from the buffer 210 according to the adjusted clock CLK_GATE.

The second device 206 receives a second clock CLK_2 and operates according to the second clock CLK_2. The second device 206 writes data of the second device 206 into the buffer 210 according to the second clock CLK_2. The buffer 210 accesses data of the memory unit 212 for the access of the first device 204 and the second device 206 at a memory clock.

The buffer 210 further comprises a first FIFO 207, a second FIFO 208 and an arbiter 209. The arbiter 209 selects the first FIFO 207 or the second FIFO 208 to access data of the memory unit 212. In this embodiment, the first FIFO 207 is set among the arbiter 209 and the first device 204, and the first FIFO 207 reads data of the memory unit 212 at the memory clock. The second FIFO 208 is set among the arbiter 209 and the second device 206, and the second FIFO 208 writes data from the second FIFO 208 into the memory unit 212 at the memory clock. The first device 204 reads data of the first FIFO 207 according to the adjusted clock CLK_GATE, and the second device 206 writes data of the second device 206 into the second FIFO 208 according to the second clock CLK_2. The memory unit 212 may be a DRAM.

The first FIFO 207 is set with a first predetermined threshold value. When the fullness of the first FIFO 207 is under the first predetermined threshold value, the arbiter 209 selects the first FIFO 207 and the first FIFO 207 reads data from the memory unit 212. Similarly, the second FIFO 208 is set with a second predetermined threshold value. When fullness of the second FIFO 208 is above than the second predetermined threshold value, the arbiter 209 selects the second FIFO 208 and the data of the second FIFO 208 are written into the memory unit 212.

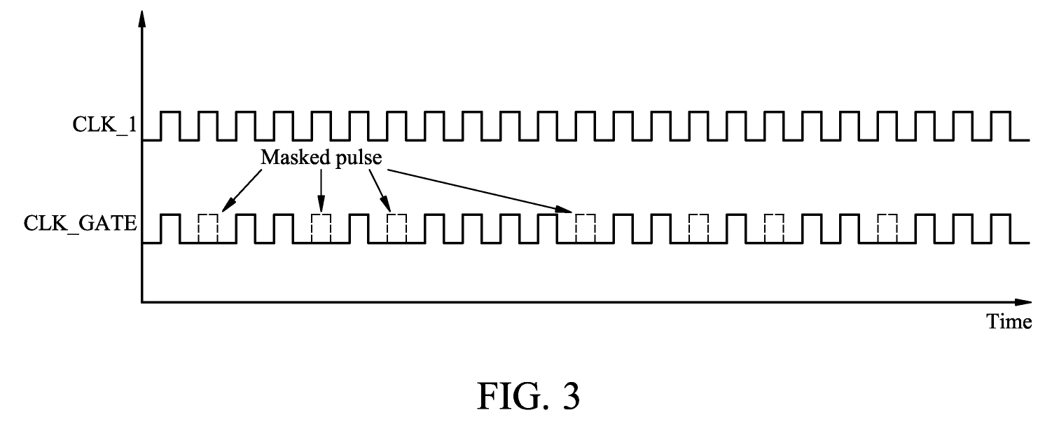

FIG. 3 is a timing chart of the first clock CLK_1 and the adjusted clock CLK_GATE in FIG. 2. The adjusting unit 202 receives the first clock CLK_1 and masks a portion of pulses of the first clock CLK_1 to generate an adjusted clock CLK_GATE to the first device 204 (as shown in FIG. 3). Obviously, in the same time period, the clock number of the adjusted clock CLK_GATE is less than the clock number of the first clock CLK_1. That is, the clock rate of the adjusted clock CLK_GATE is lower than the clock rate of the first clock CLK_1. In this embodiment, the adjusted clock CLK_GATE is instead of the first clock CLK_1 for reading the data from the first FIFO 207. That is, the first device 204 reads the data from the first FIFO 207 by a lower reading rate to avoid that the fullness of the first FIFO 207 is under the first predetermined value frequently. For example, assume that the data reading rate at the first clock CLK_1 is 200 data per second, the data reading rate at the memory clock is 100 data per second, the first predetermined value is 500, and the data reading rate at the adjusted clock CLK_GATE is 80 data per second. In the initial state, the data of the first FIFO 207 is empty, and the first FIFO 207 starts to read data from the memory unit 212 through the arbiter 209 at the memory clock (100) until the fullness of the first FIFO 207 is above the first predetermined value (500). If the first device 204 reads the data from the first FIFO 207 at the first clock CLK_1 (200), the fullness of the first FIFO 207 is under the first predetermined value (500) all the time. In the condition, a data bus is occupied by the first FIFO 207 to reading data from the memory unit 212 all the time. Thus, the reading rate is set as the adjusted clock CLK_GATE (80) to read the data of the first FIFO 207 so that the data bus is not occupied by the first FIFO 207 all the time.

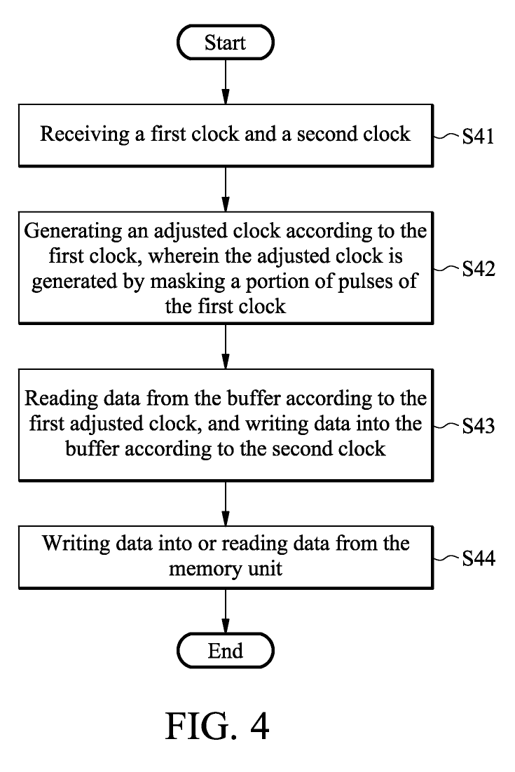

FIG. 4 is a flow chart for accessing a memory through a buffer according to one embodiment of the invention. Referring to FIG. 4, and FIG. 2, firstly, the first clock CLK_1 is transmitted to each of the adjusting unit 202 and the first device 204. The second clock CLK_2 is transmitted to the second device 206 (S41). The first clock CLK_1 is adjusted by the adjusting unit 202 to generate the adjusted clock CLK_GATE (shown in FIG. 3). In more detail, a portion of pulses of the first clock CLK_1 is masked by the adjusting unit 202 to generate the adjusted clock CLK_GATE so that the clock rate of the adjusted clock CLK_GATE is less than the clock rate of the first clock CLK_1 (S42). The first device 204 reads the buffer 210 according to the adjusted clock CLK_GATE, and the second device 206 writes data to the buffer 210 according to the second clock CLK_2 (S43). The buffer 210 writes data into or read data from the memory unit 212. In more detail, the buffer 210 reads data from the second device 208 to be written to the memory unit and reads data from the memory unit to be read by a first device 207 (S44).

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus for accessing a memory unit, comprising:
a first device operated at a first clock;
a second device operated at a second clock;
a buffer reading data from the second device to be written to the memory unit and from the memory unit to be read by the first device; and
an adjusting unit masking a portion of pulses of the first clock to generate an adjusted clock, wherein the first device reads the buffer according to the adjusted clock.

2. The apparatus for accessing a memory unit as claimed in claim 1, wherein the buffer further comprises:
a first FIFO, coupled to the first device, reading data from the memory unit if the fullness of the first FIFO is under a first predetermined threshold value to be read by the first device at the adjusted clock;
a second FIFO, coupled to the second device, storing data from the second device at the second clock to be written to the memory unit if the fullness of the second FIFO is above a second predetermined threshold value; and
an arbiter selecting the first FIFO or the second FIFO to access the memory unit.

3. The apparatus for accessing a memory unit as claimed in claim 1, wherein the memory unit is a DRAM.

4. The apparatus for accessing a memory unit as claimed in claim 1 is a video processor, and the first device and the second device are an input unit and an output unit of the video processor.

5. A method for accessing a memory unit through a buffer, the buffer reading data from a second device to be written to the memory unit and from the memory unit to be read by a first device, wherein the first device is operated at a first clock and the second device is operated at a second clock, comprising:
generating an adjusted clock by masking a portion of pulses of the first clock; and
reading the buffer according to the adjusted clock by the first device.

6. The method for accessing a memory unit as claimed in claim 5, wherein the memory unit is a DRAM.

7. The method for accessing a memory unit as claimed in claim 5 is implemented in a video processor, and the first device and the second device are an input unit and an output unit of the video processor.
